(19) United States
(12) Patent Application Publication
(10) Pub. No.: US 2019/0348198 A1
(43) Pub. Date: Nov. 14, 2019

(54) CURRENT BAR FOR A CONNECTION TERMINAL

(71) Applicant: PHOENIX CONTACT GMBH & CO. KG, Blomberg (DE)

(72) Inventors: Georg Grunenberg, Detmold (DE); Janina Lattwesen, Bad Nenndorf (DE); Lutz von Aswege, Lemgo (DE)

(21) Appl. No.: 16/461,474

(22) PCT Filed: Nov. 8, 2017
(86) PCT No.: PCT/EP2017/078618

§ 371 Date: May 16, 2019

(30) Foreign Application Priority Data
Nov. 21, 2016 (LU) 93316

(51) Int. Cl. H01B 13/06; H01B 1/02; H01B 7/18; H01B 7/38

(52) U.S. Cl. CPC H01B 13/06; H01B 7/38; H01B 7/184; H01B 1/023

(57) ABSTRACT

A current bar for a connection terminal comprises a first connection region and a second connection region which is galvanically connected to the first connection region. The current bar comprises a conductor support by which means the first connection region is galvanically connected to the second connection region, a main material constituent of the conductor support being aluminum and an electroconductive covering layer being arranged on the conductor support, an electroconductive intermediate layer being sandwiched between the conductor support and the covering layer.

The present invention relates to a current bar for a connection terminal. The present invention further relates to a connection terminal having a current bar.

In industrial connection technology, it is frequently necessary for wires, conductor cores and/or conductors to be electrically interconnected. To this end, connection terminals are known from the prior art which, for example, can be configured as terminal blocks or as bushing terminals. In many cases, for example, it is necessary for currents to be routed through a wall, for example a housing wall of an industrial electrical device. Bushing terminals are employed for this purpose, which in some cases are also described as wall feed-through terminals. Bushing terminals are intended to provide a uniformly reliable and convenient connection of an external conductor to a corresponding internal conductor of the electrical device. Bushing terminals can be of a one-piece design, in which case, in a corresponding configuration of the bushing terminal, an opening which corresponds to the cross-sectional geometry of the bushing terminal must be provided in the wall through which the electrical conductor is to be fed, into which the bushing terminal is inserted. Alternatively, it is also possible for a bushing terminal to be configured in a two-piece design, and to comprise an inner part or inner housing, and an outer part or outer housing, wherein the inner part is arranged on the inner side of a wall, or is attached to the latter, and wherein the outer part is arranged on the outer side of the wall, or is attached to the latter.

Terminal blocks are customarily latched onto mounting rails, a plurality of which, in turn, are frequently arranged in a switchgear cabinet. The basic type of terminal block is the connecting terminal unit, comprising at least two conductor terminal elements which are electrically interconnectable by means of a current bar.

In connection terminals which are known from the prior art, whether these are configured as terminal blocks or as bushing terminals, a current bar or current rail is consistently constituted of copper or a copper alloy. Copper is characterized by high electrical conductivity, of the order of 58*10⁶ S/m. As a result of the high electrical conductivity of copper, the current bar can be configured to a correspondingly compact design. In turn, this results in a compact bushing terminal.

In known connection terminals, however, specifically in high-current connection terminals, material costs for the current bar disadvantageously account for up to 50% of material costs for the entire connection terminal. For high-current connection terminals, for example, current bars are required which have a cross-sectional area of between 50 mm² and 95 mm². Consequently, material costs for a current bar having a cross-sectional area of this magnitude are very high.

The object of the present invention is the provision of current bar which can be produced more cost-effectively, whilst consistently delivering good current conduction properties.

The fundamental object of the present invention is fulfilled by a current bar having the characteristics of claim 1 of the present invention. Advantageous configurations of the current bar are described in the claims which are dependent upon claim 1.

More specifically, the fundamental object of the present invention is fulfilled by a current bar for a connection terminal, wherein the current bar comprises a first connection region and a second connection region which is galvanically connected to the first connection region. The current bar according to the invention is characterized in that the current bar comprises a conductor support, by means of which the first connection region is galvanically connected to the second connection region, wherein a main material constituent of the conductor support is aluminum, wherein an electrically conductive covering layer is arranged on the conductor support, and wherein an electrically conductive intermediate layer is sandwiched between the conductor support and the covering layer.

The current bar according to the invention, which can also be described as a current rail, has substantially lower material costs, in comparison with current bars which are produced from copper. As a result of the coating of the current bar with the covering layer, the current bar according to the invention shows a reduced contact resistance between the current bar and a conductor/current conductor which is connected to the current bar, as the covering layer, upon the application of a corresponding force, adapts to the outer shape of the connected conductor. It is thus possible, notwithstanding the lower electrical conductivity of the conductor support in comparison to that of current bars produced from copper, for the size of the current bar according to the invention to remain substantially unchanged in comparison to that of current bars produced from copper. A further advantage of the current bar according to the invention is its reduced weight, such that transport costs for current bars, or for connection terminals which are equipped with current bars according to the invention, are significantly reduced.

As a material for the conductor support, pure aluminum or an aluminum alloy can be employed.

On the grounds of its electrically conductive configuration, the covering layer is comprised of an electrically conductive material. Moreover, the covering layer preferably shows a high ductility, such that the covering layer adapts to the outer shape of a conductor by the action of ductile strain, where a force is applied to the conductor in the direction of the current bar (for example by means of clamping).

On the grounds of its electrically conductive configuration, the intermediate layer is also comprised of an electrically conductive material. The function of the intermediate layer is to protect the conductor support against corrosion, as the corrosion of the constituent aluminum of the conductor support would result in the formation of a non-conductive, or only a very poorly conducting aluminum oxide layer on the surface of the current bar.

The covering layer is preferably softer than the intermediate layer. The conductor support can also be described as a conductor core.

The first connection region and the second connection region are preferably arranged/positioned at the ends of the current bar.

The conductor support is preferably comprised of EN AW 6060 aluminum. Naturally, it is also possible for the conductor support to be formed of a different aluminum alloy.

The current bar is preferably configured such that it contains nickel, or is comprised of nickel.

Nickel has proved to be highly suitable for the protection of aluminum against corrosion.

It is further preferred that the current bar is configured such that the covering layer contains tin, or is comprised of tin.

By the employment of a tin layer as a covering layer, contact resistance between the current bar and a conductor which is connected to the current bar is reduced, as the effective contact surface between the conductor and the current bar is increased by the substantial/high ductility of the tin layer.

Specifically, in the case of an intermediate layer which is configured as a nickel layer, the covering layer which is configured as a tin layer is softer than the intermediate layer.

It is further preferred that the current bar is configured such the conductor support is sandwiched between two intermediate layers, wherein the outer side of each of the intermediate layers is covered by a covering layer, such that each intermediate layer is configured in a sandwiched arrangement between the conductor support and a covering layer.

Contact surfaces of the current bar with the layered structure are provided accordingly. In cross-section, the current bar therefore shows the following layered structure: covering layer, intermediate layer, conductor support, intermediate layer, covering layer.

The layered structure of the current bar is preferably configured symmetrically, i.e. the intermediate and covering layers configured on either side of the conductor support are identical, with respect to the layer thickness thereof.

According to a further advantageous configuration of the current bar, the latter is configured such that the covering layer entirely encloses the conductor support, wherein the intermediate layer is arranged between the conductor support and the covering layer throughout.

In the correspondingly configured current bar, the conductor support is entirely enclosed by the intermediate layer, wherein the current bar, on its outer side, is enclosed by the covering layer.

The two intermediate layers preferably incorporate nickel, or are comprised of nickel. The two outer layers preferably incorporate tin, or are comprised of tin.

The current bar is preferably configured such that a first contacting surface of the first connection region and a second contacting surface of the second connection region are configured with a ribbed structure.

By the ribbed configuration of the contacting surfaces, the adaptation of the covering layer to the shape of a conductor which is connected to the current bar, by means of ductile strain, can be further improved, such that the contact resistance between the connected conductor and the current bar is reduced.

The current bar is preferably configured such that the intermediate layer has a dimensional thickness ranging from 1 μm to 8 μm, preferably from 2 μm to 4 μm, and such that the covering layer has a dimensional thickness ranging from 2 μm to 16 μm, preferably from 4 μm to 8 μm.

A further fundamental object of the present invention is the provision of a connection terminal which can be produced more cost-effectively, whilst consistently maintaining good current conduction properties, and with unchanged external dimensions.

This fundamental object of the present invention is fulfilled by a connection terminal having the characteristics of claim 8 of the present invention. Advantageous configurations of the connection terminal are described in the exemplary embodiments which are dependent upon claim 8.

More specifically, this fundamental object of the present invention is fulfilled by a connection terminal having a first conductor locator and a second conductor locator, wherein the connection terminal is characterized in that the latter comprises one of the above-mentioned current bars, wherein the first connection region of the current bar is contactable via the first conductor locator of the connection terminal, and wherein the second connection region of the current bar is contactable via the second conductor locator of the connection terminal.

The connection terminal is preferably configured as a bushing terminal.

According to an advantageous configuration of the connection terminal which is configured as a bushing terminal, the latter is comprised of an inner part and an outer part which is connectable thereto, wherein the first conductor locator is arranged in the inner part, and the second conductor locator is arranged in the outer part.

The connection terminal is preferably configured as a terminal block.

Further advantages, details and characteristics of the invention proceed from the exemplary embodiments which are represented hereinafter. Specifically:

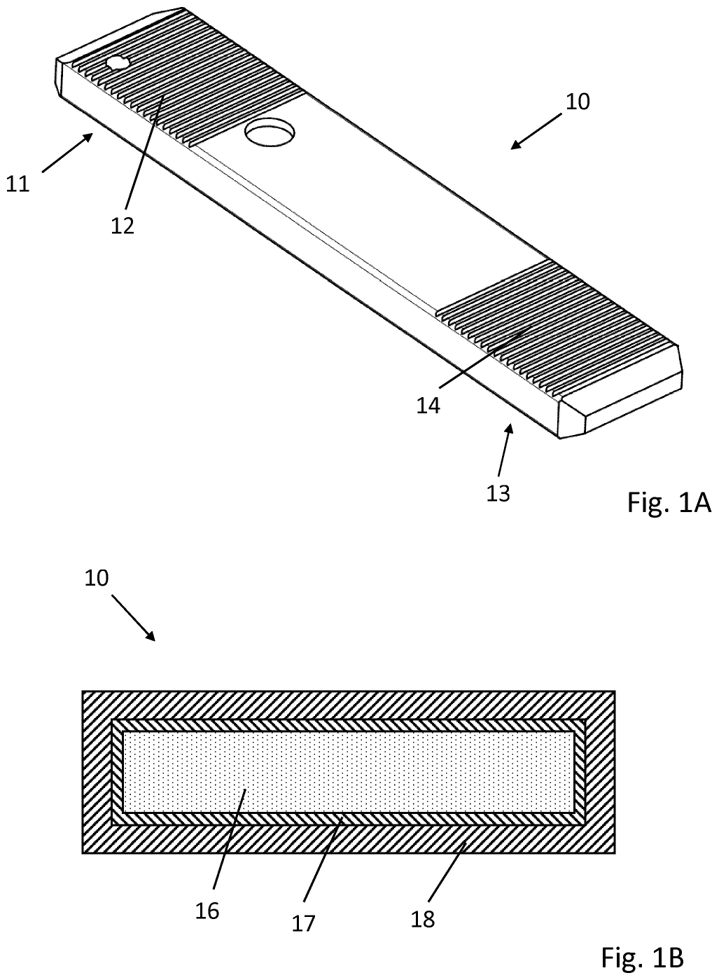

FIG. 1A: shows a perspective view of a current bar according to the invention;

FIG. 1B: shows a sectional representation of the current bar represented in FIG. 1A, in which the layered structure of the current bar can be seen;

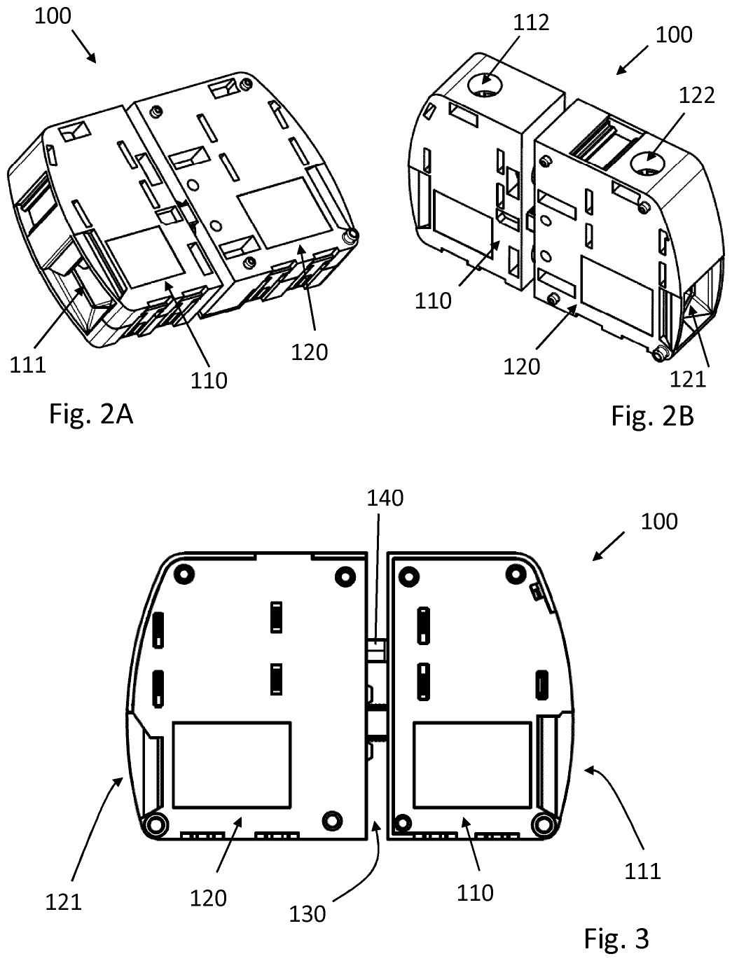

FIG. 2A: shows a perspective view of a bushing terminal according to the invention;

FIG. 2B: shows the bushing terminal represented in FIG. 2A, from a different perspective;

FIG. 3: shows a side view of the bushing terminal represented in FIGS. 2A and 2B;

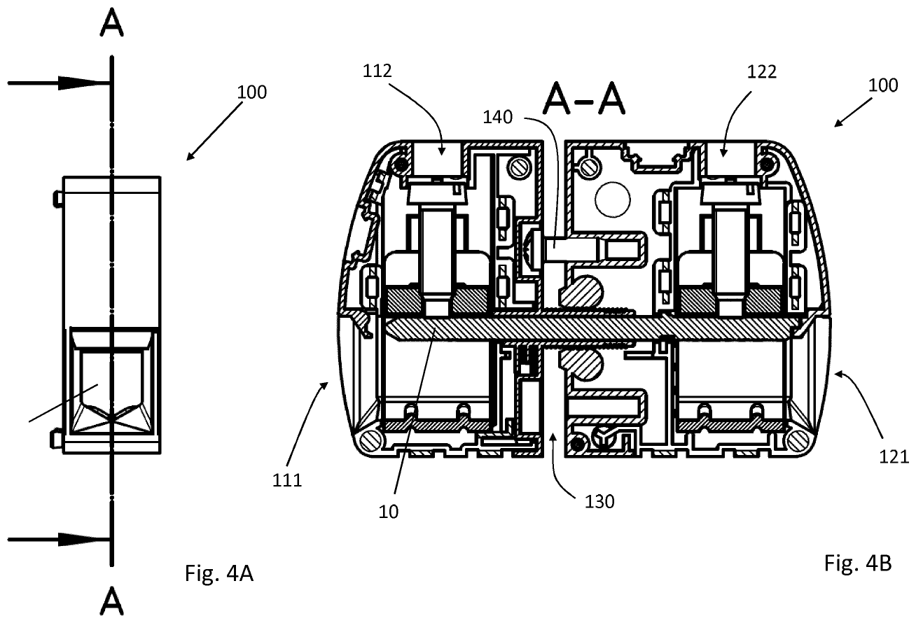

FIG. 4A: shows a frontal view of the bushing terminal represented in FIGS. 2A to 3;

FIG. 4B: shows a sectional representation of the bushing terminal represented in FIG. 4A;

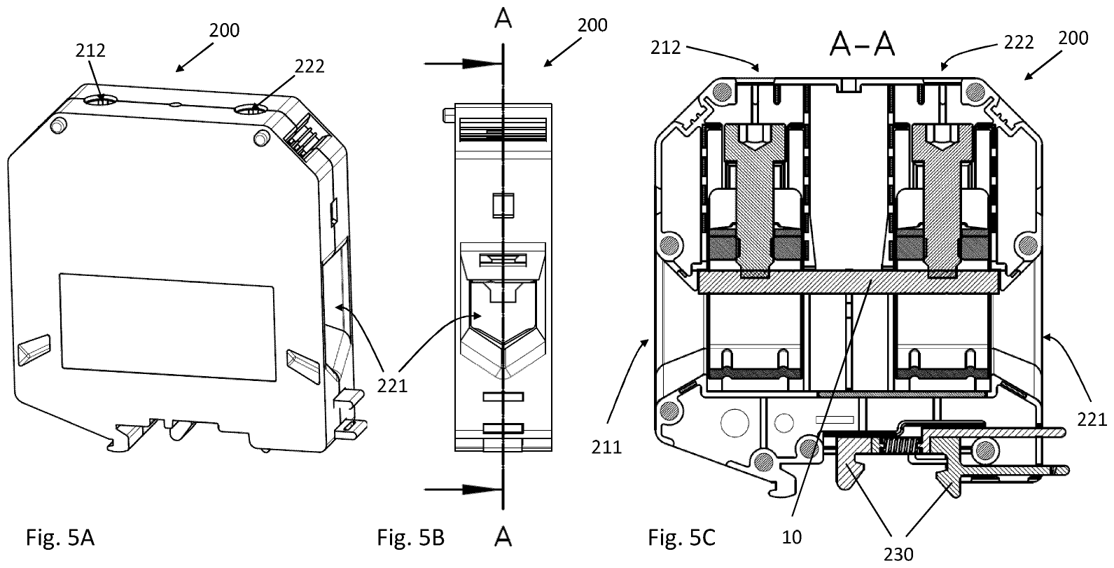

FIG. 5A: shows a perspective view of a terminal block according to the invention;

FIG. 5B: shows a frontal view of the terminal block represented in FIG. 5A; and

FIG. 5C: shows a sectional representation of the terminal block represented in FIG. 5B.

In the following description, identical reference numbers identify identical components or identical characteristics, such that a description of a component provided with reference to one figure is also valid for the remaining figures, thereby avoiding any repetitive description. Moreover, individual characteristics which are described with reference to one form of embodiment can also be employed separately in other forms of embodiment.

FIG. 1A shows a perspective representation of a current bar 10 according to the invention. FIG. 1B shows a section of the current bar 10 represented in FIG. 1A. The current bar 10, which is preferably configured for a connection terminal 100, 200 represented in FIGS. 2A to 5C, comprises a first connection region 11 and a second connection region 13 which is galvanically connected to the latter. In the first connection region 11 of the current bar 10, a first contacting surface 12 is configured and, in the second connection region 13 of the current bar 10, a second contacting surface 14 is configured. Both the first contacting surface 12 and the second contacting surface 14 are configured for the contacting of current conductors, which are not represented in the figures.

As can be seen from FIG. 1A, both the first contacting surface 12 and the second contacting surface 14 are configured with a ribbed structure such that, between the respective contacting surfaces 12, 14 and the current conductors which are not represented in the figures, an enlarged contact surface is provided between the current bar 10 and the current conductors. Contact resistance between the respective current conductors and the respective contacting surfaces 12, 14 is thus reduced.

From FIG. 1B, it can be seen that the current bar 10 according to the invention comprises a conductor support 16, by means of which the first connection region 11 is galvanically connected to the second connection region 13. In the current bar 10 according to the invention, a main material constituent of the conductor support 16 is aluminum. As a material for the current bar 10, pure aluminum or an aluminum alloy can be employed. For example, the conductor support 16 can be constituted of EN AW 6060 aluminum. Naturally, in the context of the present invention, other aluminum alloys can also be employed as a material for the conductor support 16.

The current bar 10 according to the invention further comprises at least an electrically conductive covering layer 18. The covering layer 18 delimits the current bar 10 to the exterior. In the exemplary embodiment represented, the covering layer 18 entirely encloses the conductor support 16. It can further be seen from FIG. 1B that the current bar 10 also comprises an intermediate layer 17, which is sandwiched between the conductor support 16 and the covering layer 18. As can be seen from FIG. 1B, the intermediate layer 17 entirely encloses the conductor support 16, wherein the current bar 10 and the intermediate layer 17 are entirely enclosed by the covering layer 18.

The intermediate layer 17 preferably incorporates nickel, or is entirely comprised of nickel. The covering layer 18 preferably incorporates tin, or is entirely comprised of tin. As a result of the high ductility of the covering layer 18, which is configured as a tin layer 18, the surface of the current bar 10, upon the compression thereon of a current conductor which is not represented in the figures, adapts to the external geometry of said current conductor, such that a contacting surface area between the respective contact surfaces 12, 14 and the current conductors connected thereto is enlarged. Contact resistance between the connected current conductors and the current bar 10 is reduced accordingly.

The inventors have established that, with a thickness of the intermediate layer 17 preferably ranging from 1 μm to 8 μm, wherein a thickness of 2 μm to 4 μm is further preferred, particularly good results are achieved with respect to the corrosion protection of the conductor support 16. The inventors have further established that, with a thickness of the covering layer 18 preferably ranging from 2 μm to 16 μm, wherein a thickness of 4 μm to 8 μm is further preferred, particularly good results are achieved with respect to the adaptation of the current bar 10 to the shape of a conductor which is to be connected thereto.

In FIGS. 2A to 4B, a connection terminal 100 according to the invention is represented, configured in the form of a bushing terminal 100. The bushing terminal 100 comprises an inner part 110 and an outer part 120 which is connectable to the latter. As can specifically be seen from FIGS. 3 and 4B, an intermediate region 130 or a clear space 130 is constituted between the inner part 110 and the outer part 120. In an assembled state of the bushing terminal 100 on a housing wall of an electrical device, which is not represented in the figures, the housing wall is arranged in the intermediate region 130. A first conductor locator 111 of the bushing terminal 100 is arranged in the inner part 110, and a second conductor locator 121 is arranged in the outer part 120.

As can specifically be seen from FIG. 4B, the bushing terminal 100 according to the invention comprises a current bar 10, which is described with reference to FIGS. 1A and 1B. The first connection region 11 of the current bar 10 is contactable via the first conductor locator 111 of the bushing terminal 100, and the second connection region 13 of the current bar 10 is contactable via the second conductor locator 121 of the bushing terminal 100.

FIGS. 5A to 5C represent a connection terminal 200 according to the invention, which is configured in the form of a terminal block 200. The terminal block 200 comprises a first conductor locator 211 and a second conductor locator 221. As can specifically be seen from FIG. 5C, the terminal block 200 according to the invention comprises a current bar 10, which is described with reference to FIGS. 1A and 1B. The first connection region 11 of the current bar 10 is contactable via a first conductor locator 211 of the terminal block 200, and the second connection region 13 of the current bar 10 is contactable via a second conductor locator 221 of the terminal block 200. From FIG. 5C, it can further be seen that the terminal block 200 according to the invention comprises a latching device 230, by means of which the terminal block 200 can be latched onto a bar, which is not represented in the figures.

### LIST OF REFERENCE NUMBERS

10 Current bar/current rail

11 First connection region (of current bar)

12 First contacting surface (of current bar/first connection region)

13 Second connection region (of current bar)

14 Second contacting surface (of current bar/second connection region)

16 Conductor support (of current bar)

17 Intermediate layer/nickel layer (of current bar)

18 Covering layer/tin layer (of current bar)

100 Connection terminal/bushing terminal

110 Inner part (of bushing terminal)

111 First conductor locator (of bushing terminal)

112 First tool opening (of bushing terminal)

120 Outer part (of bushing terminal)

121 Second conductor locator (of bushing terminal)

122 Second tool opening (of bushing terminal)

200 Connection terminal/terminal block

211 First conductor locator (of terminal block)

212 First tool opening (of terminal block)

221 Second conductor locator (of terminal block)

222 Second tool opening (of terminal block)

230 Latching device (of terminal block)

1. A current bar for a connection terminal, wherein the current bar comprises a first connection region and a second connection region which is galvanically connected to the latter, wherein:
the current bar comprises a conductor support, by means of which the first connection region is galvanically connected to the second connection region, wherein a main material constituent of the conductor support is aluminum,
an electrically conductive covering layer is arranged on the conductor support; and
an electrically conductive intermediate layer is sandwiched between the conductor support and the covering layer.

2. The current bar as claimed in claim 1, wherein the intermediate layer incorporates nickel, or is comprised of nickel.

3. The current bar as claimed in claim 1, wherein the covering layer incorporates tin, or is comprised of tin.

4. The current bar as claimed in claim 1, wherein:
the conductor support is configured in a sandwiched arrangement between two intermediate layers,
the outer side of each of the intermediate layers is covered by a covering layer, such that each intermediate layer is configured in a sandwiched arrangement between the conductor support and a covering layer.

5. The current bar as claimed in claim 1, wherein the covering layer entirely encloses the conductor support, wherein the intermediate layer is arranged between the conductor support and the covering layer throughout.

6. The current bar as claimed in claim 1, wherein a first contacting surface of the first connection region and a second contacting surface of the second connection region are configured with a ribbed structure.

7. The current bar as claimed in claim 1, wherein:
the intermediate layer has a dimensional thickness ranging from 1 μm to 8 μm, preferably from 2 μm to 4 μm; and
the covering layer has a dimensional thickness ranging from 2 μm to 16 μm, preferably from 4 μm to 8 μm.

8. A connection terminal having a first conductor locator and a second conductor locator, wherein:
the connection terminal comprises a current bar as claimed in claim 1;
the first connection region of the current bar is contactable via the first conductor locator of the connection terminal; and
the second connection region of the current bar is contactable via the second conductor locator of the connection terminal.

9. The connection terminal as claimed in claim 8, wherein the connection terminal is configured as a bushing terminal.

10. The connection terminal as claimed in claim 9, wherein:
the connection terminal comprises an inner part and an outer part which is connectable thereto; and
the first conductor locator is arranged in the inner part, and the second conductor locator is arranged in the outer part.

11. The connection terminal as claimed in claim 8, wherein the connection terminal is configured as a terminal block.
